(19) United States
(12) Patent Application Publication
(10) Pub. No.: US 2025/0106330 A1
(43) Pub. Date: Mar. 27, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YUKI KANAGAWA, Chiba (JP)

(21) Appl. No.: 18/891,619

(22) Filed: Sep. 20, 2024

(30) Foreign Application Priority Data
Sep. 25, 2023 (JP) 2023-160112

(51) Int. Cl. H04N 1/00

(52) U.S. Cl. CPC H04N 1/00413; H04N 1/00411; H04N 1/00474; H04N 2201/0094

(57) ABSTRACT

An image processing apparatus includes a display control unit that causes, in a case where a first operation for scrolling a predetermined area of a screen displayed on a display unit is accepted, the predetermined area of the screen to be scrolled, wherein, in a case where a setting to disable acceptance of the first operation on the screen is enabled, the display control unit displays a screen on which a second operation, different from the first operation, for scrolling the predetermined area of the screen is acceptable.

### BACKGROUND

### Field

The present disclosure relates to an information processing apparatus, a control method, and a storage medium.

### Description of the Related Art

There have been conventionally known technologies for scrolling a screen by selecting an object for scrolling the screen (scroll object). In addition, in recent years, there have been known technologies for scrolling a screen by a flick operation.

Japanese Patent Application Laid-Open No. 2018-142166 discusses an image processing apparatus that determines, when a setting to disable flick operations is activated, whether a scroll object is present on a screen, and, if the scroll object is not displayed, enables flick operations even when the setting to disable flick operations is activated.

Meanwhile, there is a demand for further improvement in user convenience on a screen that allows a scroll display.

### SUMMARY

The present disclosure is directed to further improving user convenience on a screen that allows a scroll display.

An image processing apparatus includes a display control unit configured to cause, in a case where a first operation for scrolling a predetermined area of a screen displayed on a display unit is accepted, the predetermined area of the screen to be scrolled, wherein, in a case where a setting to disable acceptance of the first operation on the screen is enabled, the display control unit displays a screen on which a second operation, different from the first operation, for scrolling the predetermined area of the screen is acceptable.

Further features of the present disclosure will become apparent from the following description of exemplary embodiments with reference to the attached drawings.

### BRIEF DESCRIPTION OF THE DRAWINGS

FIG. 1 is a schematic diagram illustrating a configuration of a system.

FIG. 2 is a block diagram illustrating an example of a hardware configuration of an image processing apparatus.

FIG. 3 is a block diagram illustrating an example of a software configuration of the image processing apparatus.

FIG. 4 is a diagram illustrating a screen on which a first touch operation is permitted.

FIG. 5 is a diagram illustrating a screen on which the first touch operation is not permitted.

FIG. 6 is a diagram illustrating a setting screen for making a setting on whether to enable/disable a scroll operation based on the first touch operation.

FIG. 7 is a flowchart illustrating a screen display process.

FIG. 8 is a diagram illustrating a home screen on which the first touch operation is permitted.

FIG. 9 is a diagram illustrating a home screen on which the first touch operation is not permitted.

### DESCRIPTION OF THE EMBODIMENTS

Hereinafter, an exemplary embodiment of the present disclosure will be described in detail with reference to the accompanying drawings. Note that the following exemplary embodiment does not limit the subject matter of the present disclosure, and not all combinations of features described in the following exemplary embodiment are necessarily essential to the solution of the present disclosure. The identical components will be described with the same reference numerals.

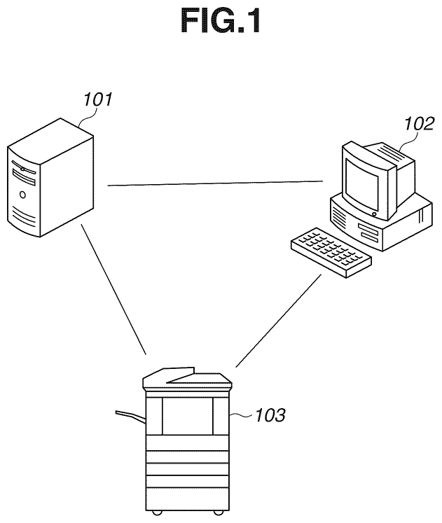

FIG. 1 is a schematic diagram illustrating a configuration of a system that includes an image processing apparatus according to a first exemplary embodiment. The system includes an image processing apparatus 103, a server 101, and a client personal computer (PC) 102, all of which are connected to a network.

In the present exemplary embodiment, a description will be given of an example in which a multi-function peripheral (MFP) having a plurality of functions is used as the image processing apparatus 103.

The MFP has a copy function of recording information on a recording medium using a recording material, a print function of printing print data sent from an external printer driver, a function of copying and reading (scanning) information recorded on a recording medium, a transmission function of transmitting scanned data to a predetermined external destination, and the like. The image processing apparatus 103 includes an operation panel on its main body, and is configured to make a setting related to a function of the image processing apparatus 103 when a user selects and execute a job based on the function based on set values. The image processing apparatus 103 may also have a function of transmitting data to another image processing apparatus and printing the data on the destination image processing apparatus (remote copy function or facsimile function) or may have other functions. The above-described functions are merely examples, and the image processing apparatus 103 is not limited to these examples. The image processing apparatus 103 may be an apparatus having a single function, and its printing method may be an electrophotographic method, an inkjet method, or another method.

It is assumed that the image processing apparatus 103 is connected to the server 101 and the client PC 102 via, for example, Ethernet® in the present exemplary embodiment, but the connection method is not limited to this example. Although a plurality of apparatuses is described here as an example, the server 101 and the client PC 102 may be configured by the same computer, for example. The server 101 and the client PC 102 may be implemented in the image processing apparatus 103, and a system may be constituted by the single image processing apparatus 103. Although an MFP is described as the image processing apparatus 103 in the present exemplary embodiment, the image processing apparatus 103 is not limited to an MFP and may be any of various types of equipment, such as a PC, a terminal device, or a smartphone.

### <Hardware Configuration of Image Processing Apparatus>

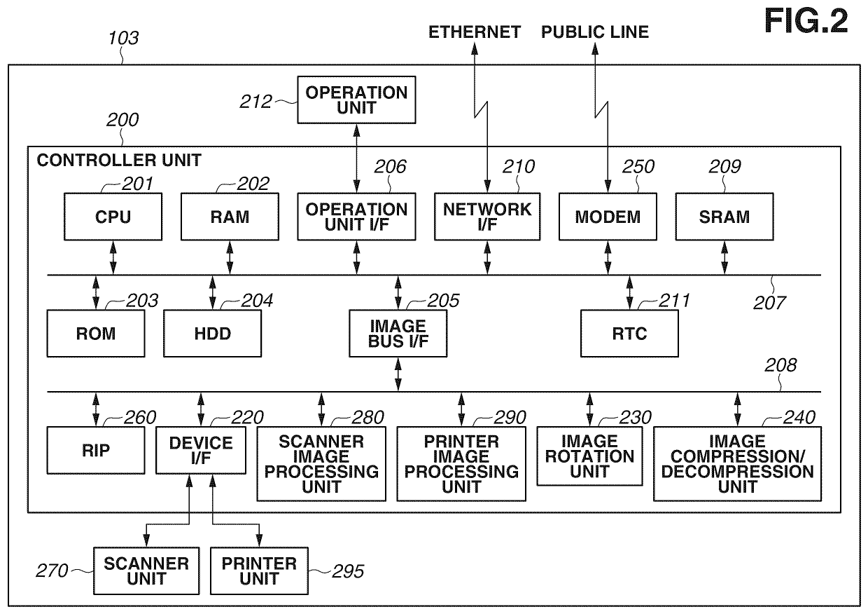

FIG. 2 is a block diagram illustrating an example of a hardware configuration of the image processing apparatus 103 in the present exemplary embodiment. The image processing apparatus 103 includes a controller unit 200, an operation unit 212, a scanner unit 270, and a printer unit 295. The controller unit 200 includes a central processing unit (CPU) 201, a random access memory (RAM) 202, a read only memory (ROM) 203, a hard disk drive (HDD) 204, an image bus interface (I/F) 205, an operation unit I/F 206, a static random access memory (SRAM) 209, a network I/F 210, a real-time clock (RTC) 211, and a modem 250. The controller unit 200 also includes a device I/F 220, an image rotation unit 230, an image compression/decompression unit 240, a raster image processor (RIP) 260, a scanner image processing unit 280, and a printer image processing unit 290.

The controller unit 200 is connected to the scanner unit 270 that is an image input device and the printer unit 295 that is an image output device. The controller unit 200 inputs and outputs image information and device information through connection to Ethernet® or a public line. The CPU 201 is a controller that controls the image processing apparatus 103. The RAM 202 is a system work memory for the operation of the CPU 201, and is also an image memory for temporarily storing image data. The ROM 203 is a boot ROM in which a boot program for the system is stored. The HDD 204 is a hard disk drive that stores system software, applications, and image data.

The operation unit I/F 206 is an interface with the operation unit 212 including a touch panel, and outputs image data to be displayed on the operation unit 212 to the operation unit 212. The operation unit I/F 206 also plays a role in transmitting information input by a user via the operation unit 212 to the CPU 201. The operation unit 212 also serves as a display unit including a liquid crystal touch panel, for example. The operation unit 212 may also include hard keys in addition to the liquid crystal touch panel and may be configured to accept inputs via the hard keys. The network I/F 210 is connected to a network to input and output information. The modem 250 is connected to a public line to input and output information.

The SRAM 209 is a non-volatile recording medium that is capable of high-speed operation. The RTC 211 is a real-time clock that continuously counts the current time even when the controller unit 200 is not powered on. The above-described devices are arranged on a system bus 207.

The image bus I/F 205 is a bus bridge that connects the system bus 207 and an image bus 208 that transfers image data at high speed, and converts a data structure. The image bus 208 is constituted by a peripheral component interconnect (PCI) bus or a bus conforming to the Institute of Electrical and Electronics Engineers (IEEE) 1394. The following devices are provided on the image bus 208. The RIP 260 is a raster image processor that develops a page description language (PDL) code into a bitmap image. The device I/F 220 connects the scanner unit 270 and the printer unit 295, which are image input/output devices, to the controller unit 200 and performs synchronous/asynchronous conversion of image data. The scanner image processing unit 280 corrects, processes, and edits input image data. The printer image processing unit 290 corrects print output image data and performs resolution conversion on the data. The image rotation unit 230 rotates image data. The image compression/decompression unit 240 performs compression/decompression processing on image data.

### <Software Configuration of Image Processing Apparatus>

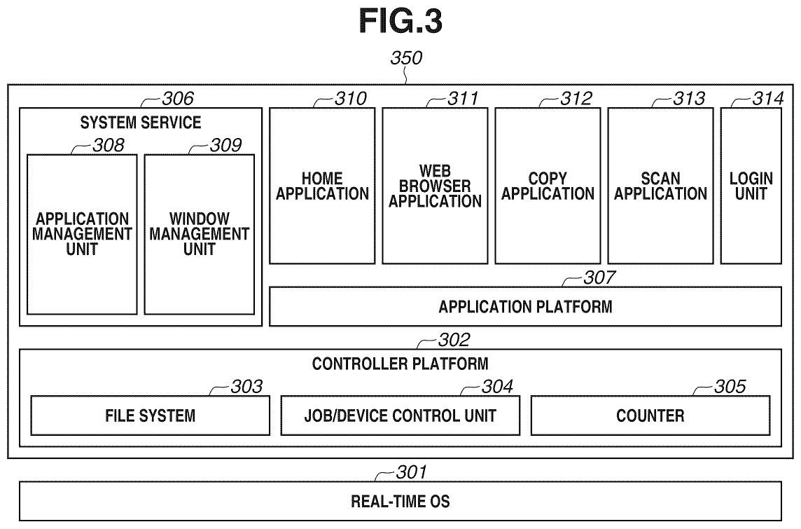

FIG. 3 is a block diagram illustrating an example of a software configuration of the image processing apparatus 103 in the present exemplary embodiment. The main software configuration illustrated in FIG. 3 is stored in the HDD 204 of the image processing apparatus 103 as firmware 350, and the firmware 350 is read into the RAM 202 and executed by the CPU 201.

The image processing apparatus 103 includes a real-time operating system (OS) 301 and the firmware 350. The firmware 350 includes a controller platform 302, a system service 306, and an application platform 307. The controller platform 302 includes a file system 303, a job/device control unit 304, and a counter 305. The system service 306 includes an application management unit 308 and a window management unit 309. The firmware 350 further includes a home application 310, a web browser application 311, a copy application 312, a scan application 313, and a login unit 314 on the application platform 307.

The real-time OS 301 is a real-time operating system that provides various resource management services and frameworks optimized to control an embedded system for software running thereon. The various resource management services and frameworks provided by the real-time OS include multitask (thread) management that manages a plurality of execution contexts of processes by the CPU 201 to allow a plurality of processes to be executed substantially in parallel. There is also inter-task communication that implements synchronization and data exchange between tasks. There are also memory management, interrupt management, various device drivers, and a protocol stack in which processing of various protocols for local interfaces, networks, and communications is implemented.

The file system 303 is a system for storing data constructed on a storage device, such as the HDD 204 or the RAM 202. The job/device control unit 304 controls the hardware of the image processing apparatus 103, and also controls jobs that utilize basic functions (printing, scanning, communication, image conversion, and the like) provided mainly by the hardware of the image processing apparatus 103. The counter 305 manages the expiration date of each application and the counter values for printing and scanning, which are to be stored in the SRAM 209.

The application management unit 308 is a management module for installing, uninstalling, starting, or stopping the applications 310, 311, 312, and 313, the login unit 314, and the like. The window management unit 309 is a management module for controlling the display order of application windows provided by the applications 310, 311, 312, and 313, the login unit 314, and the like.

The application platform 307 is middleware that enables the systems of the real-time OS 301 and the controller platform 302 to be used by the applications 310, 311, 312, and 313, the login unit 314, and the like.

The applications 310, 311, 312, and 313 are application software that implement various business models through the utilization of the functions provided by the application platform 307. The home application 310 has a menu function for selecting an application. The web browser application 311 has a web browser function for browsing a web server. The copy application 312 has a copy function for copying a paper document. The scan application 313 has a scan function for transmitting data. Upon receipt of a login notification from the login unit 314, these applications perform a screen generation process according to the logged-in user based on information included in the login notification. As an example, a case is described in which the logged-in user is prohibited from using a web browser and from performing color copy and the use of some functions is restricted. In this case, the home application 310 performs a process to disable selection of a web browser that is unavailable for the logged-in user. The copy application 312 performs a process to disable selection of a color copy button.

The login unit 314 is authentication software for performing user authentication. The login unit 314 performs a login process based on a username and a password input via the operation unit 212. If the user authentication has failed, the login unit 314 displays an error message, and if the authentication has succeeded, the login unit 314 performs a series of processes subsequent to the user authentication.

There is known a display control under which a screen is scrolled by selecting an object that is displayed on the screen and is used for scrolling the screen (operation method 1). There is also known a display control under which a screen can be scrolled based on a predetermined user operation, such as a flick operation or a drag operation (operation method 2). In general, the predetermined user operation can be accepted on a screen including an object for scrolling the screen. However, if the predetermined user operation can be accepted on a screen including an object for scrolling the screen, it may be troublesome for a user because there are two operation methods for scrolling the screen. Therefore, there is also known a technique for making a setting on whether to enable or disable the acceptance of the predetermined user operation.

However, if a screen not including an object for scrolling the screen is provided and the acceptance of the predetermined user operation is disabled, the screen cannot be scrolled. In this case, a configuration can be considered in which the acceptance of the predetermined user operation is temporarily enabled on the screen not including an object for scrolling the screen. In this configuration, however, the screen cannot be scrolled while the setting to disable the acceptance of the predetermined user operation is maintained. For example, for a user who has made the setting to disable the acceptance of the predetermined user operation because he/she does not want to perform the predetermined user operation, it may be bothersome if the acceptance of the predetermined user operation is temporarily enabled. In addition, for example, if the acceptance of the predetermined user operation is temporarily enabled despite the fact that the setting to disable the acceptance of the predetermined user operation has been made, the user may have a false recognition that the setting to disable the acceptance of the predetermined user operation may not have been made.

Therefore, in the present exemplary embodiment, based on whether the acceptance of the predetermined user operation is enabled or disabled, a control is executed to switch between displaying a screen that does not include an object for scrolling the screen and displaying a screen that includes an object for scrolling the screen. Specifically, in a case where the acceptance of the predetermined user operation is enabled, a screen that does not include an object for scrolling the screen is displayed. In a case where the acceptance of the predetermined user operation is disabled, a screen that includes an object for scrolling the screen is displayed. This can reduce the inconvenience caused by having two operation methods for scrolling the screen. In addition, it is possible to scroll the screen while maintaining the setting to disable the acceptance of the predetermined user operation. Accordingly, the user who has made the setting to disable the acceptance of the predetermined user operation because he/she does not want to perform the predetermined user operation can scroll the screen without performing the predetermined user operation. In addition, since the screen can be scrolled while maintaining the setting to disable the acceptance of the predetermined user operation, it is possible to reduce the possibility that the user may falsely recognize that the setting to disable the acceptance of the predetermined user operation may not have been made.

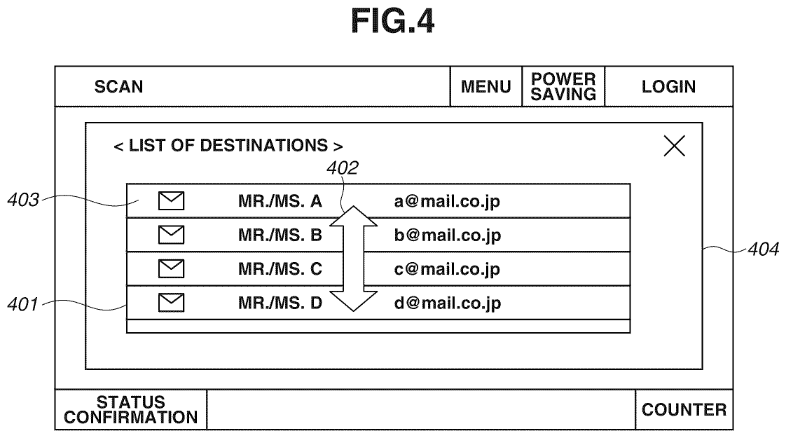

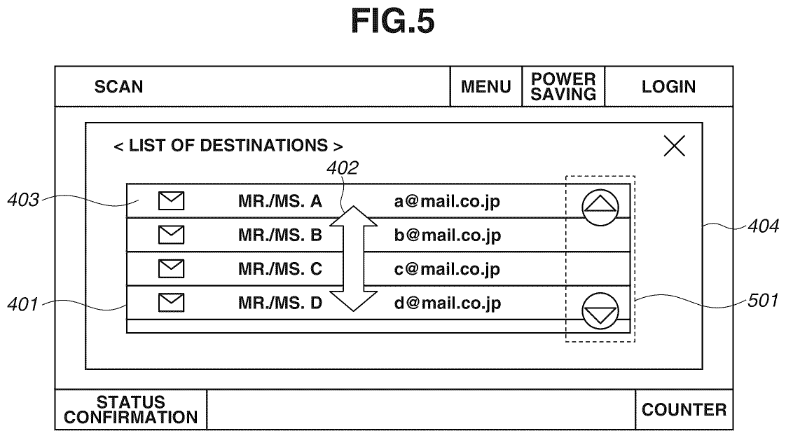

Next, a display control of the screen in the image processing apparatus 103 according to the present exemplary embodiment will be described with reference to FIGS. 4 to 7. FIGS. 4 and 5 illustrate examples of screens that display the scan application 313. The scan application 313 is an application that has a function of executing a scan and transmitting scan data generated by the execution of the scan to an external destination. The scan application 313 includes an address book (list of destination candidates), from which the user selects a destination to which the scan data is to be transmitted. The screens described in the present exemplary embodiment are each output by the window management unit 309 to the operation unit 212 and displayed on the operation unit 212. The window management unit 309 and the scan application 313 are stored as the firmware 350 in the HDD 204 of the image processing apparatus 103, and are read into the RAM 202 and executed by the CPU 201. In the present exemplary embodiment, a display control of a screen will be described using the scan application 313 as an example. However, the display control described below may be performed on another application screen. Each screen for another application displays content according to the corresponding application.

FIG. 4 illustrates a display control of a screen for which a scroll display based on a first touch operation 402 is permitted (enabled), as a first display control of a first screen 404 on which an address book is displayed. The first screen 404 in FIG. 4 displays the address book in a first area 401 that is to be displayed when a screen transition takes place from an initial screen (not illustrated) of the scan application 313. One or more items 403 corresponding to the destination(s) are displayed in the first area 401. Since the destinations are different pieces of information, the first area 401 is a selection area for selecting at least one from among different options, and the first screen 404 is a selection screen. The first area 401 may be an area in which the same items are displayed consecutively. Upon acceptance of the first touch operation 402 in the first area 401 performed by a user on the operation unit 212, the display control is performed to scroll through the items 403 in the first area 401. In other words, the display control is performed to scroll through the destinations listed in the address book. The first touch operation 402 refers to a touch operation on the operation unit 212, not a touch operation on an image or item displayed on the screen, and the example of the display control illustrated in FIG. 4 indicates that a scroll display is possible by performing the first touch operation 402 in the direction of the arrow. The first touch operation 402 is a drag operation or a flick operation, for example. The first display control is a display control to accept the first touch operation 402 in the first area 401, and not to accept a second touch operation, which is an operation different from the first touch operation 402, on an object 501 (described below with reference to FIG. 5).

FIG. 5 illustrates a display control of a screen on which a scroll display based on a second touch operation on the object 501, which is an operation different from the first touch operation 402, is permitted, as a second display control of the first screen 404 on which the address book is displayed. That is, the display control in FIG. 5 is a display control of a screen on which scroll display based on the first touch operation 402 is not permitted (disabled). The object 501 on which the second touch operation is performed is an object, image, item, or button that, when being selected, enables a scroll display of the items 403. The first area 401, the items 403, and the first screen 404 are the same as those in FIG. 4. When a touch operation on the object 501 performed by the user on the operation unit 212 is accepted, the display control is performed to scroll through the items 403 in the first area 401. In other words, the display control is performed to scroll through the destinations listed in the address book. The second touch operation is, for example, a touch operation to select (press) the object 501, or a button press operation that is detected when the object 501 is pressed or when the pressing of the object 501 is released after the object 501 is pressed.

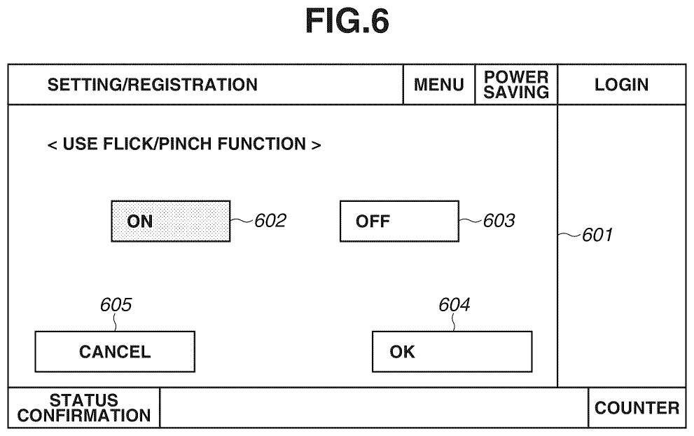

FIG. 6 illustrates an example of a screen (setting screen) describing a setting means for setting either the first display control or the second display control. The setting to be made on the setting screen of FIG. 6 is applied to the area where the first touch operation 402 is allowed, not only in the screen for the scan application 313 but also in the screens for other applications in the image processing apparatus 103. Alternatively, a setting screen like that of FIG. 6 may be provided to each application, and a setting means for setting either the first display control or the second display control may be provided to each application. Specifically, in the screen of FIG. 6, the user can set either a display control to permit (enable) the scroll display based on the first touch operation 402, or a display control not to permit (disable) the scroll display based on the first touch operation 402. The screen of FIG. 6 is a screen that is displayed in response to execution of a predetermined operation to display the screen of FIG. 6 in a setting application (not illustrated) that allows setting of various setting items related to the image processing apparatus 103. A setting area 601 includes a first setting value 602, a second setting value 603, a button 604 for confirming and storing the selection of a setting value when the button 604 is pressed with the setting value selected, and a button 605 for canceling storage of a selected setting value and closing the screen of FIG. 6. The first setting value 602 is provided as an object for setting the display control to permit the scroll display based on the first touch operation 402. That is, when the object 602 is selected and set, the first display control illustrated in FIG. 4 is executed. The second setting value 603 is provided as an object for setting the display control not to permit the scroll display based on the first touch operation 402. That is, when the object 603 is selected and set, the second display control illustrated in FIG. 5 is executed. In the factory default state (initial state) of the image processing apparatus 103, the setting value is stored with the first setting value 602 set in the setting area 601. That is, in the initial state of the image processing apparatus 103, the first display control illustrated in FIG. 4 is executed. In addition, on the setting screen of FIG. 6, it may be possible to set enabling/disabling of a pinch function (operation) together with a flick operation. The pinch operation is performed by a user pinching a touch panel using at least two pointers. An operation of moving two pointers closer to each other is a pinch-in operation, and an operation of moving two pointers away from each other is a pinch-out operation. For example, when a user performs the pinch-in operation, an image on the screen is displayed in a reduced size, and when the user performs the pinch-out operation, the image is displayed in an enlarged size.

### <Flowchart>

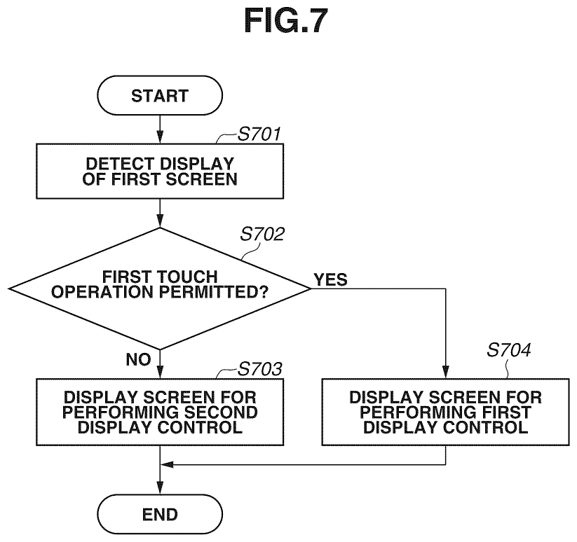

FIG. 7 is a flowchart illustrating a screen display process in the present exemplary embodiment. The process illustrated in FIG. 7 is performed when the firmware 350 stored in the HDD 204 of the image processing apparatus 103 is read into the RAM 202 and executed by the CPU 201. More specifically, the process illustrated in FIG. 7 is a process in which the scan application 313 included in the firmware 350 is read into the RAM 202 and executed by the CPU 201. As described above, the scan application 313 performs a display control in cooperation with the window management unit 309.

The process in this flowchart is started when an instruction to display the first screen is issued in step S701. The first display instruction is issued by a user pressing a button to display an address book screen for the scan application 313, for example. In step S701, the window management unit 309 detects the display of the first screen 404.

Next, in step S702, the scan application 313 determines whether the first touch operation is permitted. The scan application 313 refers to the setting value set in the setting area 601 and stored in the memory, and determines whether the first touch operation is permitted, based on the setting value. If the scan application 313 determines that the first touch operation is permitted in step S702 (YES in step S702), the process proceeds to step S704, and the scan application 313 determines that the first touch operation is not permitted in step S702 (NO in step S702), the process proceeds to step S703.

In step S703, the scan application 313 displays a screen for performing the second display control described above. Specifically, the scan application 313 determines that the display control of the screen is to be performed such that the first touch operation 402 in the first area 401 is not acceptable, but the second touch operation different from the first touch operation 402 is acceptable in the first area 401. Then, the scan application 313 displays the first screen 404 that includes the object 501 for accepting the second touch operation in the first area 401. After that, the process of this flowchart is ended.

In step S704, the scan application 313 displays a screen for performing the first display control described above. Specifically, the scan application 313 determines that the display control of the screen is to be performed such that the first touch operation 402 is acceptable in the first area 401 and the second touch operation different from the first touch operation 402 is not acceptable. Then, the scan application 313 displays the first screen 404 that does not include the object 501 for accepting the second touch operation in the first area 401. After that, the process of this flowchart is ended.

As described above, in the present exemplary embodiment, based on whether the acceptance of the predetermined user operation is enabled or disabled, a control is executed to switch between displaying a screen that does not include an object for scrolling the screen and displaying a screen that includes an object for scrolling the screen. Specifically, when the acceptance of the predetermined user operation is enabled, a screen that does not include an object for scrolling the screen is displayed. When the acceptance of the predetermined user operation is disabled, a screen that includes an object for scrolling the screen is displayed. This can reduce the inconvenience caused by having two operation methods for scrolling the screen. In addition, it is possible to provide the scroll display of the screen while maintaining the setting to disable the acceptance of the predetermined user operation. Accordingly, a user who has disabled the acceptance of the predetermined user operation because he/she does not want to perform the predetermined user operation can scroll the screen without performing the predetermined user operation. In addition, since the screen can be scrolled while maintaining the setting to disable the acceptance of the predetermined user operation, it is possible to reduce the possibility that the user may falsely recognize that the setting to disable the acceptance of the predetermined user operation may not have been made.

### Other Exemplary Embodiments

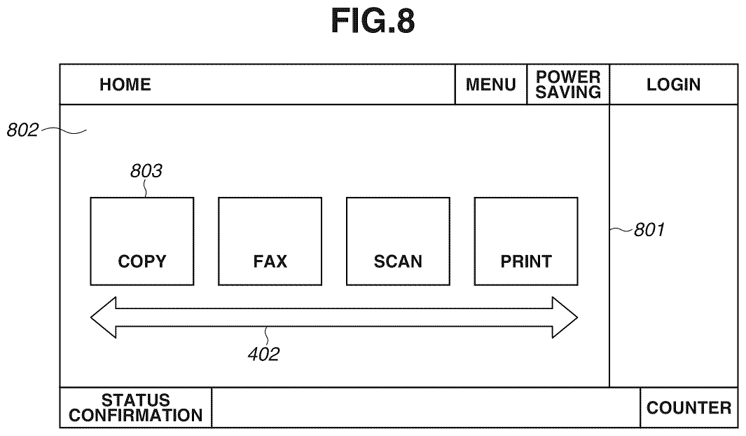

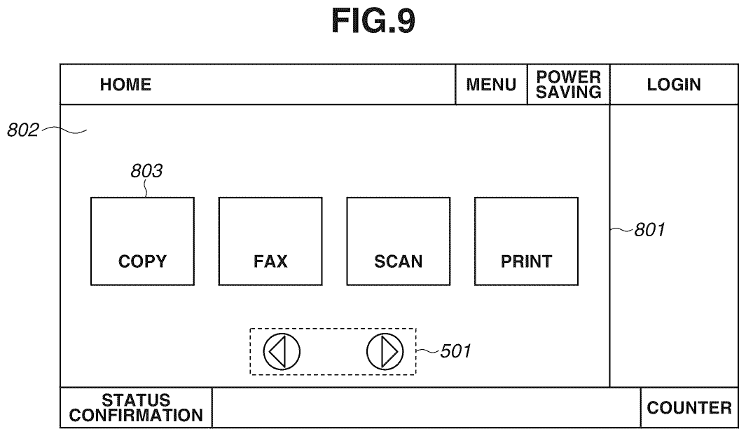

In the above-described exemplary embodiment, the first screen 404 has been described as a list display screen that displays destinations as illustrated in FIGS. 4 and 5, but the first screen 404 is not limited thereto. For example, the above-described exemplary embodiment may be implemented on a home screen 801 that allows the selection of one function from among a plurality of functions (application programs) as illustrated in FIGS. 8 and 9, or a preview screen (not illustrated) that displays a product obtained as a result of printing or as a result of scanning.

An example of the home screen 801 for selecting a function will be specifically described. FIG. 8 illustrates the home screen 801 on which a scroll display is possible and the acceptance of the predetermined user operation is permitted. In FIG. 8, items 803 in a first area 802 are to be scrolled based on the first touch operation 402. The items 803 herein are icons indicating respective functions, for example. FIG. 9 illustrates the home screen 801 on which a scroll display is possible and the acceptance of the predetermined user operation is not permitted. In the example of FIG. 9, the items 803 in the first area 802 are scrolled based on the object 501 on which the second touch operation different from the first touch operation 402 is performed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-160112, filed Sep. 25, 2023, which is hereby incorporated by reference herein in its entirety.

What is claimed is:

1. An image processing apparatus comprising:
a display control unit configured to cause, in a case where a first operation for scrolling a predetermined area of a screen displayed on a display unit is accepted, the predetermined area of the screen to be scrolled,
wherein, in a case where a setting to disable acceptance of the first operation on the screen is enabled, the display control unit displays a screen on which a second operation, different from the first operation, for scrolling the predetermined area of the screen is acceptable.

2. The image processing apparatus according to claim 1, wherein the first operation is a drag operation or a flick operation.

3. The image processing apparatus according to claim 1, wherein the second operation is an operation of selecting an object for scrolling the predetermined area of the screen.

4. The image processing apparatus according to claim 3, wherein the object for scrolling the predetermined area of the screen is a button for scrolling the predetermined area of the screen.

5. The image processing apparatus according to claim 1, wherein the screen on which the second operation is acceptable is a screen that includes an object for scrolling the predetermined area in the predetermined area.

6. The image processing apparatus according to claim 1, wherein, in a case where the first operation is acceptable on the screen, the display control unit displays, on the display unit, a screen on which the first operation is acceptable and the second operation is not acceptable.

7. The image processing apparatus according to claim 1, further comprising a setting unit configured to make a setting on whether to accept the first operation on the screen,
wherein, in a case where the setting unit makes a setting indicating that the first operation is not acceptable on the screen, the display control unit displays a screen on which the first operation is not acceptable and the second operation is acceptable.

8. The image processing apparatus according to claim 7, wherein, in a case where the setting unit makes a setting indicating that the first operation is acceptable, the display control unit displays a screen on which the first operation is acceptable and the second operation is not acceptable.

9. The image processing apparatus according to claim 1, wherein the display control unit displays, on the display unit, a setting screen for making a setting on whether to enable acceptance of the first operation on the screen.

10. The image processing apparatus according to claim 1, wherein the image processing apparatus has a plurality of functions including at least a function of scanning a recording medium and transmitting scan data obtained by the scanning to an external device.

11. The image processing apparatus according to claim 10, wherein the predetermined area is an area that includes a plurality of destination candidates to which the scan data obtained by the scanning is to be transmitted.

12. The image processing apparatus according to claim 1, wherein the predetermined area is an area that includes the plurality of functions from among which one function is selectable.

13. A control method for an image processing apparatus, the control method comprising:
performing, in a case where a first operation for scrolling a predetermined area of a screen displayed on a display unit is accepted, a display control to cause the predetermined area of the screen to be scrolled,
wherein, in a case where a setting to disable acceptance of the first operation on the screen is enabled, the performing the display control includes displaying a screen on which a second operation, different from the first operation, for scrolling the predetermined area of the screen is acceptable.

14. A non-transitory computer-readable storage medium storing a program for causing a computer of an image processing apparatus to execute a control method, the control method comprising:
performing, in a case where a first operation for scrolling a predetermined area of a screen displayed on a display unit is accepted, a display control to cause the predetermined area of the screen to be scrolled,
wherein, in a case where a setting to disable acceptance of the first operation on the screen is enabled, the performing the display control includes displaying a screen on which a second operation, different from the first operation, for scrolling the predetermined area of the screen is acceptable.
